(19) United States
(12) Patent Application Publication
(10) Pub. No.: US 2013/0090582 A1
(43) Pub. Date: Apr. 11, 2013

(54) Roller Massager

(71) Applicants: April Bertram, Canton, OH (US); Jason Crowell, Akron, OH (US)

(72) Inventors: April Bertram, Canton, OH (US); Jason Crowell, Akron, OH (US)

(73) Assignee: THE HYGENIC CORPORATION, Akron, OH (US)

(21) Appl. No.: 13/270,352

(22) Filed: Oct. 11, 2011

(51) Int. Cl. A61H 15/00

(52) U.S. Cl. 601/119

(57) ABSTRACT

The present invention provides in some embodiments, a device for massaging and treating a person's muscles. The device can include an elongate cylindrical center and a roller section rotatably positioned about the outer surface of the elongate cylindrical center shaft and extending at least a portion of a distance between the first end of the elongate cylindrical center shaft and the second end of the elongate cylindrical center shaft. A first handle can be coupled to the first end of the elongate cylindrical center shaft. The first handle can also be removable, such that the interchangeable roller section can be removed and changed. A second handle can be coupled to the second end of the elongate cylindrical center shaft. The second handle can be configured to prevent the roller section from sliding off of the elongate cylindrical center shaft in a direction of the second end.

### FIELD OF THE INVENTION

The present invention generally relates to a therapeutic device. More particularly, the present invention pertains to a massager for treating a person's musculature.

### BACKGROUND OF THE INVENTION

Massage has long been used to treat tight, stiff, and injured muscles, because benefits, such as prevention and prediction of muscle injuries, improvement of strength, flexibility, and endurance, dispersal of lactic acid, and accelerated recovery, are numerous. Athletes and exercise aficionados have long turned to massage to improve performance and ease aching muscles. Using a licensed massage therapist each time massage would be beneficial, but could easily become prohibitively expensive. Additionally, there are times when immediate treatment is necessary. Therefore, hand held massage devices were developed to address these needs. Hand held massage devices are also often used to treat trigger points. One type of hand held massage device is a wand that can be rolled over a person's muscles to treat the ailments and provide the improvements described above. The massage wand can include a roller or rollers over its outer surface. Unfortunately, these devices do not offer any variety in roller design unless a user buys multiple products, and therefore, cannot treat an array of muscle problems with a single device.

It is therefore desirable to provide a roller massager device capable of supporting various types of rollers.

### SUMMARY OF THE INVENTION

The foregoing needs are met, to a great extent, by the present invention, wherein in some embodiments a roller massager that is capable of overcoming the disadvantages described herein at least to some extent is provided.

In accordance with an embodiment of the present invention, a roller massager for exercise, training, therapy, massage, and rehabilitation includes an elongate cylindrical center shaft having an outer surface, a first end and a second end, and a longitudinal axis extending from the first end of the elongate cylindrical center shaft to the second end of the elongate cylindrical center shaft. The roller massager can also include a roller section rotatably positioned about the outer surface of the elongate cylindrical center shaft and extending at least a portion of a distance between the first end of the elongate cylindrical center shaft and the second end of the elongate cylindrical center shaft. A first handle can be coupled to the first end of the elongate cylindrical center shaft. The first handle can be configured to prevent the roller section from sliding off of the elongate cylindrical center shaft in a direction of the first end. The first handle can also be removable, such that the interchangeable roller section can be removed and changed. A second handle can be coupled to the second end of the elongate cylindrical center shaft. The second handle can be configured to prevent the roller section from sliding off of the elongate cylindrical center shaft in a direction of the second end.

In accordance with another embodiment of the present invention, a roller massager can include an elongate center shaft having an outer surface and having a longitudinal axis extending from the first end of the elongate cylindrical center shaft to the second end of the elongate cylindrical center shaft. An interchangeable unibody roller section can be positioned over the outer surface of the elongate center shaft and can extend at least a portion of a length of the elongate center shaft. The roller section can also extend along the outer surface of the elongate center shaft in a direction parallel to the longitudinal axis of the elongate center shaft. A handle can be coupled to an end of the elongate center shaft and configured to prevent the roller section from sliding off of the elongate center shaft in a direction of the second end. The handle can also be removable such that the interchangeable roller section can be removed and interchanged.

In accordance with still another aspect of the present invention a roller massager can include an elongate center shaft having an outer surface and having a longitudinal axis extending from the first end of the elongate cylindrical center shaft to the second end of the elongate cylindrical center shaft. The roller massager can also include an interchangeable roller section having multiple segments. Each segment can surround a portion of the outer surface of the elongate center shaft and can extend at least a portion of a length of the elongate center shaft. The segments can also extend along the outer surface of the elongate center shaft in a direction parallel to the longitudinal axis of the elongate center shaft. A handle can be coupled to an end of the elongate center shaft and can be configured to prevent the roller section from sliding off of the elongate center shaft in a direction of the second end. The handle can also be removable such that the interchangeable roller section can be removed and interchanged.

In accordance with another embodiment of the roller massager the roller section can be freely rotatable about the outer surface of the elongate cylindrical center shaft. The roller section can include ridges extending along an outer surface of the roller section in a direction parallel to the longitudinal axis of the elongate cylindrical center shaft, and in some embodiments the ridges can cover the entire outer surface of the roller. The roller section can have a unibody construction or can include multiple segments. If the roller has multiple segments, each segment of the roller section can be freely and independently rotatable about the outer surface of the elongate cylindrical center shaft. The roller section can be formed from at least one of foam, rubber, thermoplastic elastomer, or plastic. The roller can also be substantially rounded about its outer surface.

There has thus been outlined, rather broadly, certain embodiments of the invention in order that the detailed description thereof, herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates a view of a roller massager in accordance with an embodiment of the invention.

FIG. 2 illustrates a sectional view of the roller massager illustrated in FIG. 1 in accordance with an embodiment of the invention.

FIGS. 3A-3D illustrate roller sections in accordance with an embodiment of the invention.

FIGS. 4A-4D illustrate a sectional view of the roller sections illustrated in FIG. 4 in accordance with an embodiment of the invention.

### DETAILED DESCRIPTION

The present invention provides in some embodiments, a device for massaging and treating a person's muscles. The device can include an elongate cylindrical center and a roller section rotatably positioned about the outer surface of the elongate cylindrical center shaft and extending at least a portion of a distance between the first end of the elongate cylindrical center shaft and the second end of the elongate cylindrical center shaft. A first handle can be coupled to the first end of the elongate cylindrical center shaft. The first handle can also be removable, such that the interchangeable roller section can be removed and changed. A second handle can be coupled to the second end of the elongate cylindrical center shaft. The second handle can be configured to prevent the roller section from sliding off of the elongate cylindrical center shaft in a direction of the second end.

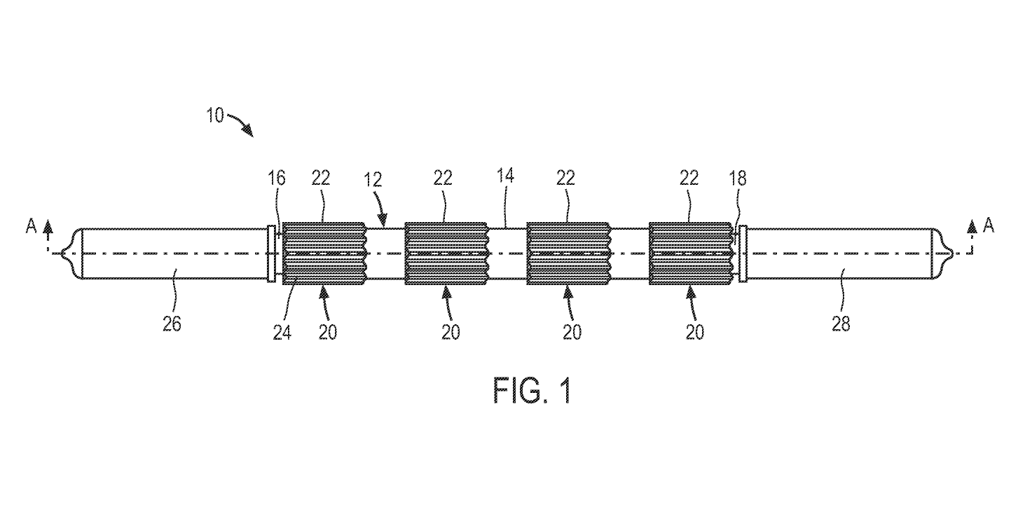

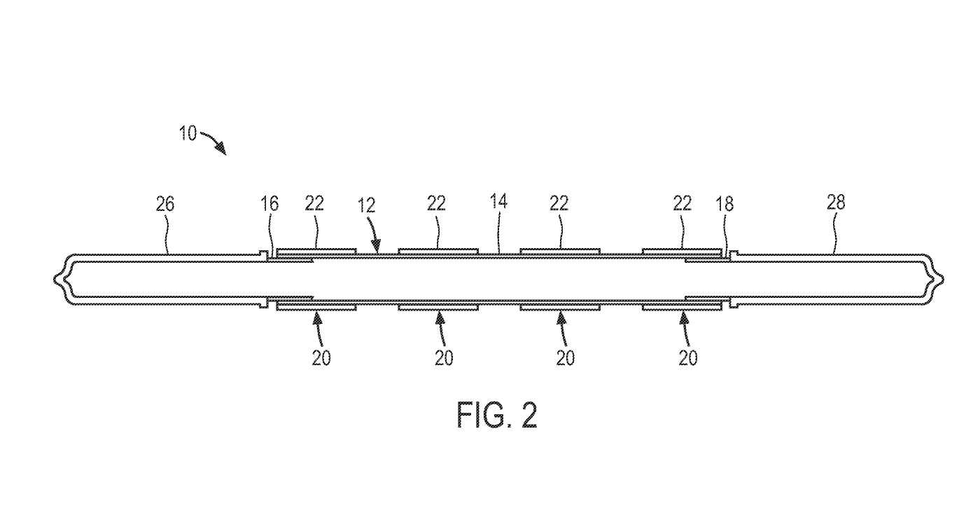

The invention will now be described with reference to the drawing figures, in which like reference numerals refer to like parts throughout. FIG. 1 illustrates a view of a roller massager device 10 and FIG. 2 illustrates a sectional view of the roller massager device taken along axis “A” of FIG. 1, in accordance with an embodiment of the present invention. The roller massager device 10 can include an elongate center shaft 12 having an outer surface 14. The elongate center shaft 12 can also have a first end 16 and a second end 18, and a longitudinal axis “A” extending between the first end 16 and the second end 18. Generally, the elongate center shaft 12 can be cylindrical in shape, as illustrated in FIG. 1. The elongate center shaft 12, can be formed from a plastic, metal, foam, or polymer tubing or solid rod, or any other material suitable for forming the elongate center shaft 12.

FIGS. 1 and 2 also illustrate a roller section 20, rotatably positioned around the elongate center shaft 12 of the roller massager device 10. The roller section 20 can extend from the first end 16 of the elongate center shaft 12 to the second end 18 of the elongate center shaft 12. Alternately, the roller section 20 can extend along only a portion of elongate center shaft 12. The roller section 20 can configured to rotate 360 degrees freely about the outer surface 14 of the elongate center shaft 12. However, any suitable range of rotation could also be used. The roller section 20 can take the form of multiple segments of uniform length, as illustrated in the example of FIGS. 1 and 2. Alternately, the roller section 20 can have a unibody construction, segments having different lengths, or any other suitable construction. Generally, an outer surface 22 of the roller section 20 can take a generally curved or cylindrical shape, but any suitable geometry for the outer surface 22 can be used.

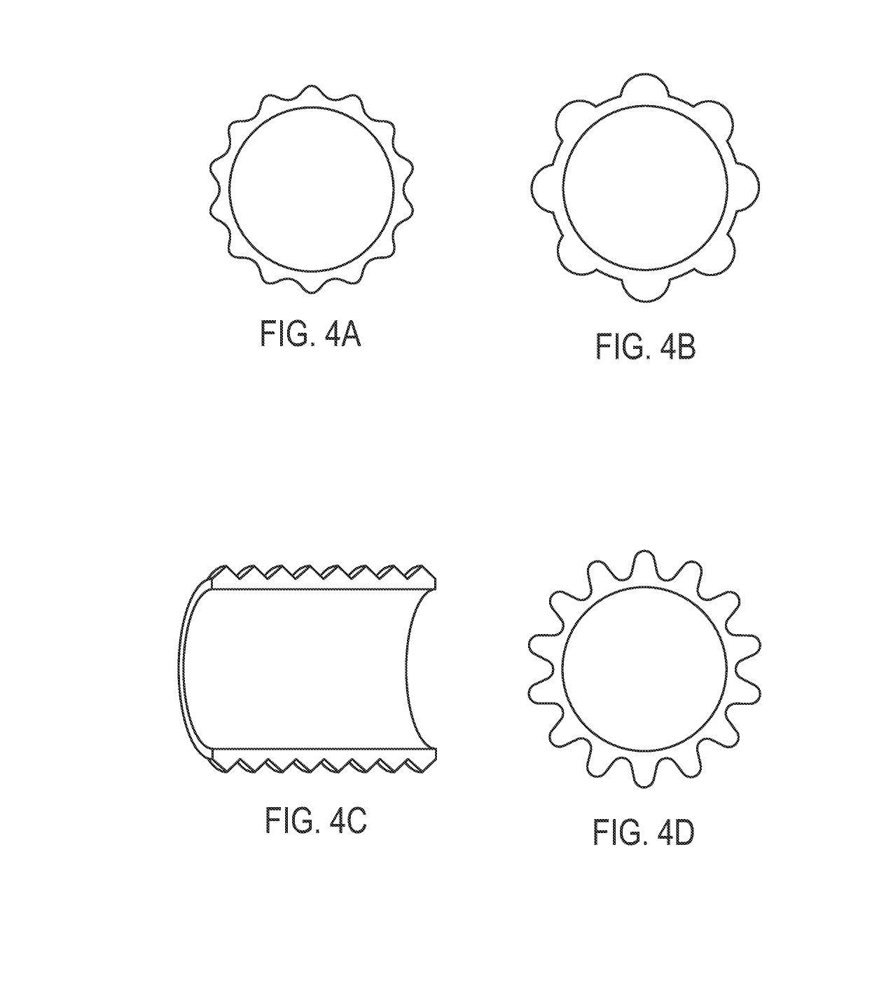

The outer surface 22 of the roller section 20 can include a texture. As illustrated in FIG. 1, the roller section 20 includes surface texture in the form of ridges 24 extending along the outer surface 22 of the roller section 20. In the example shown in FIG. 1, the ridges 24 extend lengthwise along the roller section 20, in a direction parallel to the longitudinal axis “A” of the elongate center shaft 12. The texture of the outer surface 22 of the roller section 20 can take many forms, as illustrated herein in FIGS. 4 and 5. These examples are not meant to be limiting, however, and the texture of the outer surface of the roller section can take any form suitable for the purpose of treating a person's musculature. The texture can also be configured to cover all of or just a portion of the outer surface 22 of the roller section 20. Additionally, the roller section 20 can be formed from any suitable material such as foam, rubber, any durometer plastic, or thermoplastic elastomer.

Also, as illustrated in FIGS. 1 and 2 a first handle 26 and a second handle 28 can be attached to the roller massager 10. The first handle 26 can be coupled to the first end 16 of the elongate center shaft 12, and the second handle 28 can be coupled to the second end 18 of the elongate center shaft 12. Either one of or both of the first and second handles 26 and 28 can also be removably attached to the elongate center shaft 12. The attachment of the first and/or second handles 26 and 28 can be such that either one of the handles can be easily removed. Many different forms of attachment can be used such as providing threads on the first and/or second end 16 and 18 of the elongate center shaft and within handles 26 and 28, the handles 26 and 28 can also be held in place frictionally, or by any other means suitable for connecting the handles 26 and 28 to the elongate center shaft. The shape of the first and second handles 26 and 28 can also be configured such that the roller section 20 is prevented from sliding off of the elongate center shaft 12. The handles can be formed from any suitable material such as plastic, foam, or rubber. The handles 26 and 28 may also include a textured outer surface in order to improve the user's grip on the roller massager device 10.

At least one of the handles 26 and 28 can be removable in order to facilitate the interchangeability of the roller section 20. If at least one of the handles 26 and 28 is removable, the roller section 20 can be removed and a different roller section can be used in its place. The interchangeability of these roller sections allows a user flexibility in the use of the roller massager device 10. For example, if the roller sections are interchangeable the user is able to target different muscles, apply different levels of firmness and massage to the muscles, and create a progression of massage and therapy to the muscles over time.

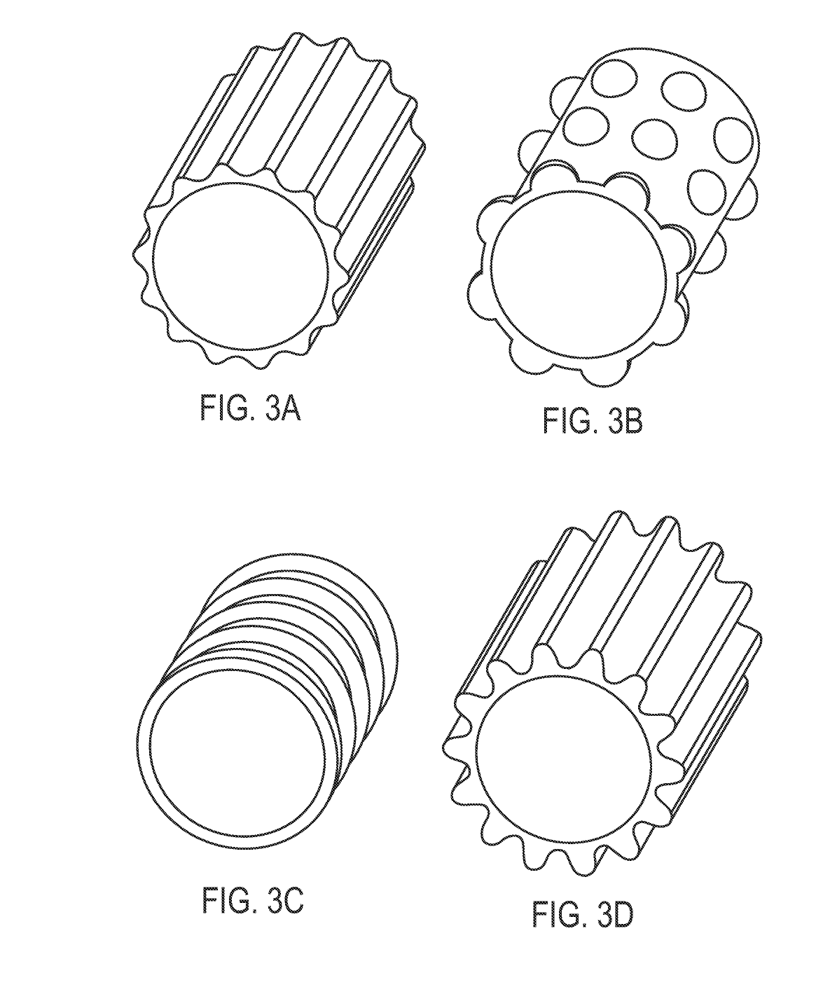

FIGS. 3A-3D illustrate different textures for an outer surface of a roller section in accordance with an embodiment of the invention, and FIGS. 4A-4D show a sectional view of the textured roller sections illustrated in FIGS. 3A-3D. The different surface textures illustrated in these figures are not to be considered limiting, but are simply examples of various surface textures that can be used for the roller section. These textures can also be combined on a single segment of the roller section. Alternately, in a roller section having multiple segments, the segments can have varying surface textures. Additionally, various factors can be changed in order to create a progression for the roller sections. For instance, the depth of the texture on the surface of the roller section can be increased or decreased to create a different degrees of treatment. The material used to form the roller sections can also be changed. For example, the density of the material can be increased or decreased in order to provide different degrees of treatment. The material itself can also be varied for instance a progression could include a soft foam and a progression of different materials ending with a harder plastic. The examples discussed above are merely examples and are not to be considered limiting. The roller sections can be provided in any combination of material and surface texture appropriate for providing the desired treatment.

The many features and advantages of the invention are apparent from the detailed specification, and thus, it is intended by the appended claims to cover all such features and advantages of the invention which fall within the true spirit and scope of the invention. Further, because numerous modifications and variations will readily occur to those skilled in the art, it is not desired to limit the invention to the exact construction and operation illustrated and described, and accordingly, all suitable modifications and equivalents may be resorted to falling within the scope of the invention.

What is claimed is:

1. A roller massager for exercise, training, therapy, massage, and rehabilitation comprising:
an elongate cylindrical center shaft having an outer surface, having a first end and a second end, and having a longitudinal axis extending from the first end of the elongate cylindrical center shaft to the second end of the elongate cylindrical center shaft;
a roller section rotatably positioned about the outer surface of the elongate cylindrical center shaft and extending at least a portion of a distance between the first end of the elongate cylindrical center shaft and the second end of the elongate cylindrical center shaft;
a first handle coupled to the first end of the elongate cylindrical center shaft, the first handle being configured to prevent the roller section from sliding off of the elongate cylindrical center shaft in a direction of the first end and the first handle being removable such that the roller section can be removed; and
a second handle coupled to the second end of the elongate cylindrical center shaft, the second handle being configured to prevent the roller section from sliding off of the elongate cylindrical center shaft in a direction of the second end.

2. The roller massager of claim 1, wherein the roller section is freely rotatable about the outer surface of the elongate cylindrical center shaft.

3. The roller massager of claim 1, wherein the roller section comprises ridges extending along an outer surface of the roller section in a direction parallel to the longitudinal axis of the elongate cylindrical center shaft.

4. The roller massager of claim 3, wherein the ridges cover the entire outer surface of the roller section.

5. The roller massager of claim 1 further comprising the roller section having a unibody construction.

6. The roller massager of claim 1, wherein the roller section comprises multiple segments.

7. The roller massager of claim 6, wherein each segment of the roller section is freely and independently rotatable about the outer surface of the elongate cylindrical center shaft.

8. The roller massager of claim 1, wherein the roller section comprises at least one of foam, rubber, thermoplastic elastomer, or plastic.

9. The roller massager of claim 1, wherein the roller section is substantially rounded about its outer surface.

10. A roller massager comprising:
an elongate center shaft having an outer surface and having a longitudinal axis extending from the first end of the elongate cylindrical center shaft to the second end of the elongate cylindrical center shaft;
an interchangeable unibody roller section surrounding the outer surface of the elongate center shaft and extending at least a portion of a length of the elongate center shaft wherein the roller section extends along the outer surface of the elongate center shaft in a direction parallel to the longitudinal axis of the elongate center shaft;
a handle coupled to an end of the elongate center shaft and configured to prevent the roller section from sliding off of the elongate center shaft in a direction of the second end and the handle being removable such that the interchangeable roller section can be removed and interchanged.

11. The roller massager of claim 10, wherein the roller section is freely rotatable about the outer surface of the elongate center shaft.

12. The roller massager of claim 10, wherein the roller section comprises ridges extending along an outer surface of the roller section in a direction parallel to the longitudinal axis of the elongate center shaft.

13. The roller massager of claim 12, wherein the ridges cover the entire outer surface of the roller section.

14. The roller massager of claim 10, wherein the roller section comprises one of foam, rubber, or low durometer plastic.

15. The roller massager of claim 10, wherein the roller section is substantially rounded about its outer surface.

16. A roller massager comprising:
an elongate center shaft having an outer surface and having a longitudinal axis extending from the first end of the elongate cylindrical center shaft to the second end of the elongate cylindrical center shaft;
an interchangeable roller section having multiple segments, each segment surrounding a portion of the outer surface of the elongate center shaft and extending at least a portion of a length of the elongate center shaft wherein the segments extend along the outer surface of the elongate center shaft in a direction parallel to the longitudinal axis of the elongate center shaft;
a handle coupled to an end of the elongate center shaft and configured to prevent the roller section from sliding off of the elongate center shaft in a direction of the second end and the handle being removable such that the interchangeable roller section can be removed and interchanged.

17. The roller massager of claim 16, wherein the roller section is freely rotatable about the outer surface of the elongate center shaft.

18. The roller massager of claim 16, wherein the roller section comprises ridges extending along an outer surface of the roller section in a direction parallel to the longitudinal axis of the elongate center shaft.

19. The roller massager of claim 16, wherein each segment of the multiple segments of the roller section is freely and independently rotatable about the outer surface of the elongate center shaft.

20. The roller massager of claim 16, wherein the roller section comprises one of foam, rubber, or low durometer plastic.
